(19) United States
(12) Patent Application Publication
(10) Pub. No.: US 2025/0238671 A1
(43) Pub. Date: Jul. 24, 2025

(54) APPARATUS AND METHOD FOR POST TRAINING QUANTIZATION OF HYBRID VISION TRANSFORMER

(71) Applicant: ELECTRONICS AND TELECOMMUNICATIONS RESEARCH INSTITUTE, Daejeon (KR)

(72) Inventors: Je-Min LEE, Daejeon (KR); Yong-In KWON, Daejeon (KR)

(73) Assignee: ELECTRONICS AND TELECOMMUNICATIONS RESEARCH INSTITUTE, Daejeon (KR)

(21) Appl. No.: 18/678,574

(22) Filed: May 30, 2024

(30) Foreign Application Priority Data
Jan. 22, 2024 (KR) 10-2024-0009725

(51) Int. Cl. G06N 3/08; G06N 3/0464; G06V 10/82

(52) U.S. Cl. CPC G06N 3/08; G06N 3/0464; G06V 10/82

(57) ABSTRACT

Disclosed herein is an apparatus and method for post-training quantization of a hybrid vision transformer. The apparatus includes memory in which at least one program is recorded and a processor for executing the program. The program calculates a quantization parameter for quantizing a pretrained neural network model and optimizes the quantization parameter so as to minimize a reconstruction error between a first output value of the neural network model before quantization and a second output value of the neural network model after quantization by inputting a predetermined number of pieces of data, the neural network model may be configured with a convolutional neural network and a transformer, and the convolutional neural network and the transformer may be connected by a bridge block.

### CROSS REFERENCE TO RELATED APPLICATION

This application claims the benefit of Korean Patent Application No. 10-2024-0009725, filed Jan. 22, 2024, which is hereby incorporated by reference in its entirety into this application.

### BACKGROUND OF THE INVENTION

### 1. Technical Field

The disclosed embodiment relates to technology for quantizing an Artificial Intelligence (AI) neural network.

### 2. Description of the Related Art

Vision transformers are replacing convolutional neural network models in various visual intelligence applications because of the strength of global representation, but it is difficult to apply these vision transforms to small devices such as edge/mobile devices due to high computational requirements.

In order to solve this problem, a hybrid architecture that combines a convolutional neural network and a transformer is proposed. Additionally, quantization methods for lightweighting a model itself can also be applied.

Meanwhile, quantization methods include Quantization-Aware Training (QAT) and Post-Training Quantization (PTQ). Among these, Post-Training Quantization (PTQ) is more widely used in practice because it enables calibration of a pretrained model using a small number of unlabeled datasets.

### SUMMARY OF THE INVENTION

An object of the disclosed embodiment is to reduce the required computation amount of a hybrid vision transformer and enable the hybrid vision transformer to be effectively executed even in a device having limited resources.

Another object of the disclosed embodiment is to perform Post-Training Quantization (PTQ) of a hybrid vision transformer.

An apparatus for post-training quantization (PTQ) of a hybrid vision transformer according to an embodiment includes memory in which at least one program is recorded and a processor for executing the program, the program may calculate a quantization parameter for quantizing a pretrained neural network model and calculate the quantization parameter optimized based on a reconstruction error between a first output value of the neural network model before quantization and a second output value of the neural network model after quantization by inputting a predetermined number of pieces of data, the neural network model may be configured with a convolutional neural network and a transformer, and the convolutional neural network and the transformer may be connected by a bridge block.

Here, the program may optimize the quantization parameter individually for each of layers included in the convolutional neural network and the transformer and optimize the quantization parameter for all of layers included in the bridge block.

Here, the quantization parameter may include a scaling factor for a weight and a scaling factor for an input activation, and each of the scaling factors may be set within a predetermined search range.

Here, the quantization parameter may further include granularity for determining the number of scaling factors for each layer.

Here, the quantization parameter may further include a quantization scheme for determining whether a quantization section is symmetric or asymmetric.

A method for post-training quantization of a hybrid vision transformer according to an embodiment comprises calculating a quantization parameter for quantizing a pretrained neural network model and calculating the quantization parameter optimized based on a reconstruction error between a first output value of the neural network model before quantization and a second output value of the neural network model after quantization by inputting a predetermined number of pieces of data, the neural network model may be configured with a convolutional neural network and a transformer, and the convolutional neural network and the transformer may be connected by a bridge block.

Here, the quantization parameter may be optimized individually for each of layers included in the convolutional neural network and the transformer, and the quantization parameter may be optimized for all of layers included in the bridge block.

Here, the quantization parameter may include a scaling factor for a weight and a scaling factor for an input activation, and each of the scaling factors may be set within a predetermined search range.

Here, the quantization parameter may further include granularity for determining the number of scaling factors for each layer.

Here, the quantization parameter may further include a quantization scheme for determining whether a quantization section is symmetric or asymmetric.

A method for post-training quantization of a hybrid vision transformer according to an embodiment includes acquiring a first output value of a pretrained neural network model by inputting a predetermined number of pieces of data and calculating a quantization parameter optimized based on a reconstruction error between the first output value and a second output value of a quantized neural network model, the neural network model may be configured with a convolutional neural network and a transformer, and the convolutional neural network and the transformer may be connected by a bridge block.

Here, the quantization parameter may include a scaling factor for a weight and a scaling factor for an input activation, and each of the scaling factors may be set within a predetermined search range.

Here, the quantization parameter may further include granularity for determining the number of scaling factors for each layer.

Here, the quantization parameter may further include a quantization scheme for determining whether a quantization section is symmetric or asymmetric.

Here, calculating the quantization parameter may further include calculating an error between the second output value and the first output value by acquiring the second output value of the quantized neural network model individually for each of the layers included in the convolutional neural network and the transformer; and calculating an error between the second output value and the first output value by acquiring the second output value of the quantized neural network model for all of the layers included in the bridge block.

Here, calculating the quantization parameter may further include acquiring a gradient value for each layer or the bridge block through error backpropagation of a second neural network model after a predetermined number of pieces of data is input to the pretrained second neural network model and propagated in a forward direction.

Here, calculating the quantization parameter may further include generating a predetermined number of candidates for the quantization parameter for each layer of the neural network model within a predetermined range.

Here, calculating the quantization parameter may further include searching for a quantization parameter that minimizes an error by alternately selecting quantization parameters included in the candidates for the quantization parameter for each layer.

Here, searching for the quantization parameter may comprise optimizing the quantization parameter using a diagonal matrix that has the calculated error and a square of a gradient value acquired for each layer as elements thereof.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a schematic block diagram of an apparatus for post-training quantization (PTQ) of a hybrid vision transformer according to an embodiment;

FIG. 2 is an exemplary view of a hybrid vision transformer applied to an embodiment;

FIGS. 3 to 5 are flowcharts for explaining a method for post-training quantization of a hybrid vision transformer according to an embodiment;

FIG. 6 is an exemplary view of a quantization (Q-HyViT) algorithm of a hybrid vision transformer according to an embodiment; and

FIG. 7 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

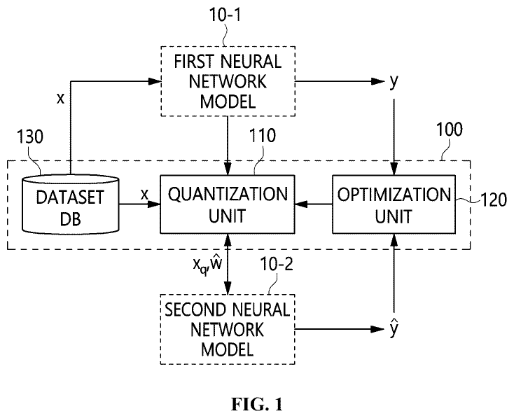

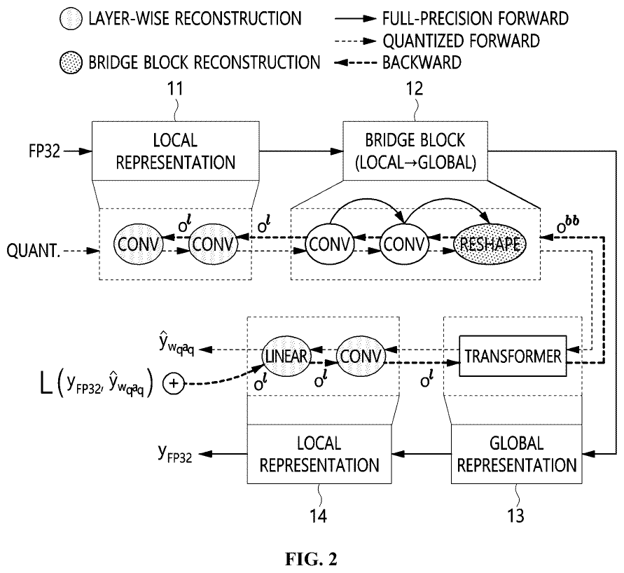

FIG. 1 is a schematic block diagram of an apparatus for post-training quantization of a hybrid vision transformer according to an embodiment, and FIG. 2 is an exemplary view of a hybrid vision transformer applied to an embodiment.

Referring to FIG. 1, the apparatus 100 for post-training quantization of a hybrid vision transformer according to an embodiment (referred to as an ‘apparatus’ hereinbelow) may generate a second neural network model 10-2 by quantizing a pretrained first neural network model 10-1.

Here, the neural network model may be a hybrid vision transformer according to an embodiment.

The hybrid vision transformer is a neural network model for image recognition, and may be configured by combining convolutional neural networks (CNNs) 11 and 14 for local representations and a transformer 13 for global representations, as illustrated in FIG. 2. Accordingly, the hybrid vision transformer may reduce the size thereof compared to a vision transformer model configured with only a transformer.

Here, the convolutional neural network 11 and the transformer 13 may be connected by a bridge block (BB) 12. That is, the bridge block 12 may convert the local representation output from the convolutional neural network 11 into a global representation and input the global representation to the transformer 13, or may convert the global representation output from the transformer into a local representation and input the local representation to the convolutional neural network.

However, the hybrid vision transformer illustrated in FIG. 2 is merely an example for helping the understanding, and the present disclosure is not limited thereto. That is, the embodiment may be applied to hybrid vision transformers having various architectures.

In an embodiment, the size and the computational amount of a pretrained neural network model are significantly reduced by combining the hybrid vision transformer architecture with quantization technology, so that the neural network model can be used in edge/small devices.

Also, according to an embodiment, quantization errors specific to a hybrid architecture are minimized by employing a new quantization method in which the bridge block 12 is taken into account, whereby the accuracy of a neural network model after quantization may be prevented from being degraded.

The apparatus 100 may include a quantization unit 110, an optimization unit 120, and a dataset database (DB) 130.

Here, the quantization unit 110 may quantize the first neural network model 10-1 to the second neural network model 10-2 using a predetermined quantization parameter.

Here, the quantization parameter may include a scaling factor for a weight w and a scaling factor for an input activation x.

Accordingly, in the case of uniform quantization, the quantization unit 110 may uniformly quantize the weight w and the input activation x with respective scaling factors. For example, the input activation x may be quantized as shown in Equation (1) below:

$${x}_{q} = Q ( {x}_{r} ) = clip ( round ( \frac{{x}_{r}}{{Δ}_{x}} + zp ) , min , max ) \qquad ( 1 )$$

In Equation (1), xᵣ denotes a real number (32 bits), and x_{q} denotes a quantized value (e.g., 8 bits). Δₓ denotes a scaling value, and may be set depending a quantization scheme that is symmetric or asymmetric. zp is a zero point, and may be present only when the quantization scheme is asymmetric.

The optimization unit 120 may optimize the quantization parameter to be used in the above-described quantization unit 110.

The dataset DB 130 may store a predetermined number of unlabeled pieces of data. The dataset is used for calibration of a pretrained neural network model, and may include a small amount of data. For example, hundreds of pieces of data may be stored.

That is, the optimization unit 120 calculates the quantization parameter optimized based on a reconstruction error, which is the difference between the first output value of the first neural network model 10-1 and the second output value of the second neural network model 10-2, by inputting the pieces of data stored in the dataset DB 130, thereby optimizing the quantization parameter.

That is, the task loss L, [symbol] =Cross Entropy(ŷ,y), is optimized. Here, ŷ is the output value of the quantized second neural network model 10-2, and y is the output value of the first neural network model 10-1 that is not quantized. The difference between ŷ and y is the difference between expectation values E, corresponding to the average of task losses for the multiple pieces of data stored in the dataset DB 130, and may be calculated as shown in Equation (2) below:

$$𝔼 [ ℒ ( x , y , \hat{w} ) ] - 𝔼 [ ℒ ( x , y , w ) ] \approx {ϵ}^{T} {\overline{g}}^{( w )} + \frac{1}{2} {ϵ}^{T} {\overline{H}}^{( w )} ϵ \qquad ( 2 )$$

In Equation (2), x denotes an activation, y denotes an output value, and w denotes a pretrained weight.

Here, because quantization can be defined as adding a small perturbation ∈ to w, the quantized weight ŵ may be represented as shown in Equation (3) below:

$$\hat{w} = w + ϵ \qquad ( 3 )$$

Also, g̅^{(w)} (g̅^{(w)}= [symbol] [∇_{w} [symbol] (x, y, ŵ)]) in Equation (2) denotes a gradient, and may be ignored because it approaches 0 when training is sufficiently performed. Also, H̅^{(w)} (H̅^{(w)}= [symbol] [∇_{w}² [symbol] (x, y, ŵ)]) in Equation (2) denotes a Hessian matrix.

Here, when small amounts of data stored in the dataset DB 130 are used as described above, the quantization parameter optimized using Equation (2) may be overfitted to the small amounts of data. Therefore, according to an embodiment, an approximate value is calculated using Taylor series expansion in Equation (2). Here, because E is a relatively small value, a second-order Taylor series expansion may be used.

Also, in order to reduce the computational complexity, a method of comparing only the difference between the final output values of the respective layers of a neural network model is employed (∈=Δw→ΔO=Ô−O). Consequently, Equation (2) may be approximated as shown in Equation (4) below:

$${ϵ}^{T} {\overline{H}}^{( x )} ϵ \approx Δ {O}^{T} {\overline{H}}^{( O )} Δ O \qquad ( 4 )$$

The quantization scaling value Δₓ is optimized by minimizing the final loss by estimating the Hessian matrix H using Equation (4).

Meanwhile, according to an embodiment, the optimization range of the scaling factor for the weight may be as shown in Equation (5), and the optimization range of the scaling factor for the input activation may be as shown in Equation (6).

$$[ α \frac{MAX \vert {w}_{l} \vert}{{2}^{k - 1}} , β \frac{MAX \vert {w}_{l} \vert}{{2}^{k - 1}} ] \qquad ( 5 )$$

$$[ α \frac{MAX \vert {x}_{l} \vert}{{2}^{k - 1}} , β \frac{MAX \vert {x}_{l} \vert}{{2}^{k - 1}} ] \qquad ( 6 )$$

In Equation (5) and Equation (6), α and β may denote values for determining the range for searching for the scaling values.

That is, a predetermined number of candidates for the scaling factor for the weight w may be selected within the range of Equation (5), and a predetermined number of candidates for the scaling factor for the activation x may be selected within the range of Equation (6).

Meanwhile, in order to deal with a highly dynamic activation range caused due to the bridge block having the gap between the local and global representations generated in the hybrid vision transformer and the architecture that combines the convolutional neural network with the transformer, the following Q-HyViT proposes hybrid reconstruction error minimization.

According to an embodiment, a reconstruction strategy is determined by identifying whether a layer is part of the bridge block.

That is, the quantization parameter may be optimized individually for each of the layers included in the convolutional neural network and transformer, and the quantization parameter may be optimized for all of the layers included in the bridge block.

The reconstruction objective O^{bb} of the hybrid approach according to this embodiment may be represented as shown in Equation (7) below:

$${O}^{b b} = \{ \begin{matrix}{w}_{n}^{bb} {w}_{n - 1}^{bb} ⋯ {w}_{1}^{bb} {x}^{bb} , & If a layer is in a bridge block \\ {w}^{ℓ} {x}^{ℓ} , & Otherwise bb is equal to ℓ\end{matrix} \qquad ( 7 )$$

That is, when a layer is part of the bridge block as shown in Equation (7), O^{bb} for calculating the reconstruction error may include all of the layers within the bridge block.

Meanwhile, the quantization parameter according to an embodiment may further include granularity for determining the number of scaling factors for each layer. For example, when a convolutional layer has ten channels and when different scaling factors are used in the respective channels, the number of scaling factors may be set to 10.

Also, the quantization parameter according to an embodiment may further include a quantization scheme for determining whether a quantization section is symmetric or asymmetric. Here, when the quantization section is asymmetric, the zero point is adjusted using a zero offset.

That is, in the post-training quantization process according to an embodiment, a granularity level and a quantization scheme suitable for each layer are determined.

Also, in an embodiment, hybrid reconstruction not only enables the hybrid vision transformer to achieve minimal quantization errors but also automatically determines quantization granularity and a quantization scheme for each layer by using the hybrid reconstruction equation following Equation (8) below and the reconstruction objective O^{bb} as a guide.

$${min}_{Δ , g , s} 𝔼 [ Δ {O}^{( bb ) , T} , {H}^{{O}^{( bb )}} Δ {O}^{( bb )} ] \approx {min}_{Δ , g , s} 𝔼 [ Δ {O}^{( bb ) , T} , diag ( {( \frac{\partial L}{\partial {O}_{1}^{( bb )}} )}^{2} , ⋯ , {( \frac{\partial L}{\partial {O}_{\vert {O}^{bb} \vert}^{( bb )}} )}^{2} ) Δ {O}^{( bb )} ] \qquad ( 8 )$$

In Equation (8), bb is determined to be a bridge block or a certain layer (bb∈[Bridgeblock, a layer]). ΔO^{(bb)} denotes the difference between output values Oₙ^{bb} before and after quantization.

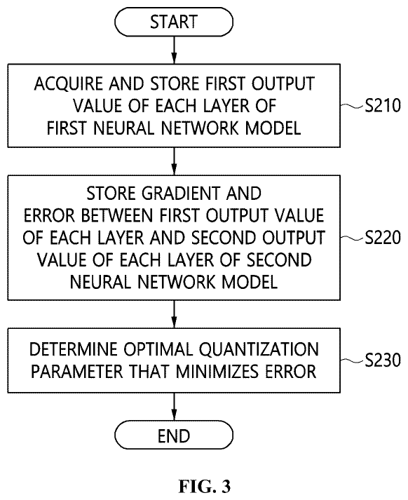

FIGS. 3 to 5 are flowcharts for explaining a method for post-training quantization of a hybrid vision transformer according to an embodiment.

Referring to FIG. 1 and FIG. 3, the apparatus 100 acquires a first output value for each layer of a first neural network model 10-1 before quantization by inputting a predetermined number of pieces of data at step S210.

Subsequently, the apparatus 100 optimizes a quantization parameter so as to minimize a reconstruction error between the first output value for each layer and a second output value for each layer of a second neural network model 10-2 after quantization at steps S220 to S230.

Here, the quantization parameter may include a scaling factor for a weight and a scaling factor for an input activation.

Also, the quantization parameter may further include at least one of granularity for determining the number of scaling factors for each layer, or a quantization scheme for determining whether a quantization section is symmetric or asymmetric, or a combination thereof.

According to an embodiment, the apparatus 100 calculates and stores a gradient and the error between the first output value for each layer and the second output value for each layer of the second neural network model at step S220.

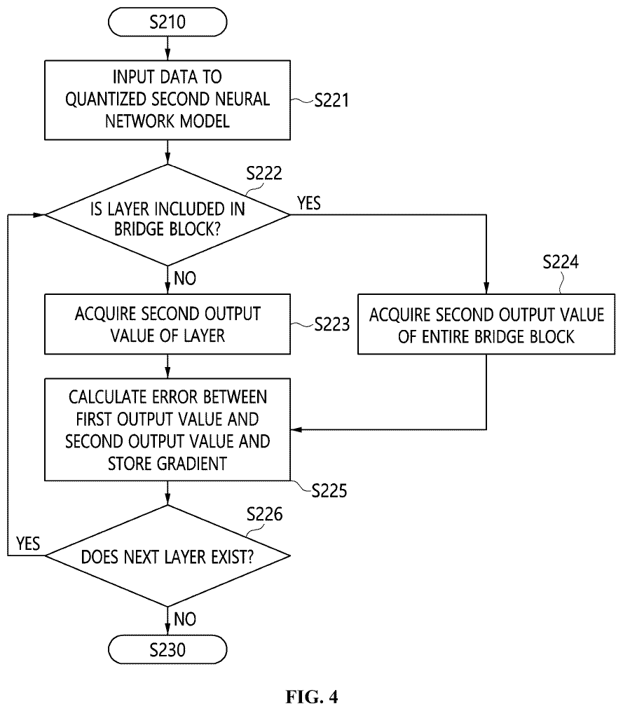

Describing step S220 in detail with reference to FIG. 4, the apparatus 100 inputs data to the quantized second neural network model 10-2 at step S221.

Subsequently, the apparatus 100 acquires the second output value for each layer of the second neural network model 10-2.

Here, when the corresponding layer is not included in abridge block at step S222, the apparatus 100 acquires the second output value of the layer at step S223. That is, the output value is acquired individually for each of the layers included in the convolutional neural network and the transformer.

Conversely, when the corresponding layer is included in the bridge block at step S222, the apparatus 100 acquires the second output value of all of the layers of the bridge block at step S224. That is, only the output value of the final layer of the bridge block is acquired.

Subsequently, the apparatus 100 calculates the error between the first output value and the second output value, calculates the gradient based on the error, and stores the gradient at step S225. That is, the error is calculated individually for each of the layers included in the convolutional neural network and the transformer, and the error for all of the layers included in the bridge block is calculated.

Also, as described above, the Hessian matrix H approximated through Tayer expansion in Equation (2) is estimated through the diagonal matrix

$$( diag ( {( \frac{\partial L}{\partial {O}_{1}^{( bb )}} )}^{2} , ⋯ , {( \frac{\partial L}{\partial {O}_{\vert {O}^{bb} \vert}^{( bb )}} )}^{2} )$$

as shown in Equation (8).

To this end, although not illustrated in the drawing, the apparatus 100 additionally acquires a gradient value for each layer through error backpropagation of the second neural network model 10-2 in which a predetermined number of pieces of data is input and propagated in a forward direction (forward propagation) and then stores the gradient value.

When a subsequent layer is present in the second neural network model at step S226, the apparatus 100 goes to step S222. That is, steps S222 to S226 are repeatedly performed for all of the layers included in the second neural network model.

Subsequently, the apparatus 100 according to an embodiment calculates and determines the optimal quantization parameter that minimizes the error at step S230.

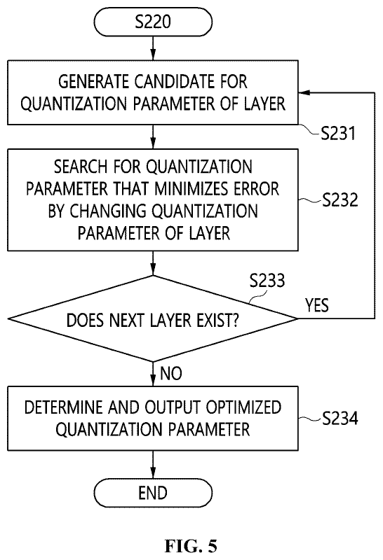

Describing step S230 in detail with reference to FIG. 5, the apparatus 100 generates candidates for the quantization parameter of each layer at step S231.

That is, each of scaling factors may be set within a predetermined search range. For example, a predetermined number of candidates for the scaling factor may be generated within the range defined in Equation (5) and Equation (6).

Also, a predetermined number of candidates for granularity and a quantization scheme may be generated.

Subsequently, the apparatus 100 searches for a quantization parameter minimizing the error by alternately changing the quantization parameters included in the candidates for the quantization parameter for each layer at step S232. The apparatus 100 repeatedly performs steps S231 and S232 for the layers of the second neural network model at step S223.

Subsequently, the apparatus 100 determines the optimized quantization parameter based on the calculated error and outputs the same at step S230.

That is, the quantization parameter that minimizes the expectation value E using the error and the Hessian matrix, calculated as shown in Equation (8) above, may be extracted. Here, the Hessian matrix may be estimated as a diagonal matrix that has the square of the gradient value of each layer, acquired through error backpropagation as described above, as the element thereof.

Meanwhile, steps S220 to S230 may be repeated a number of times according to an embodiment.

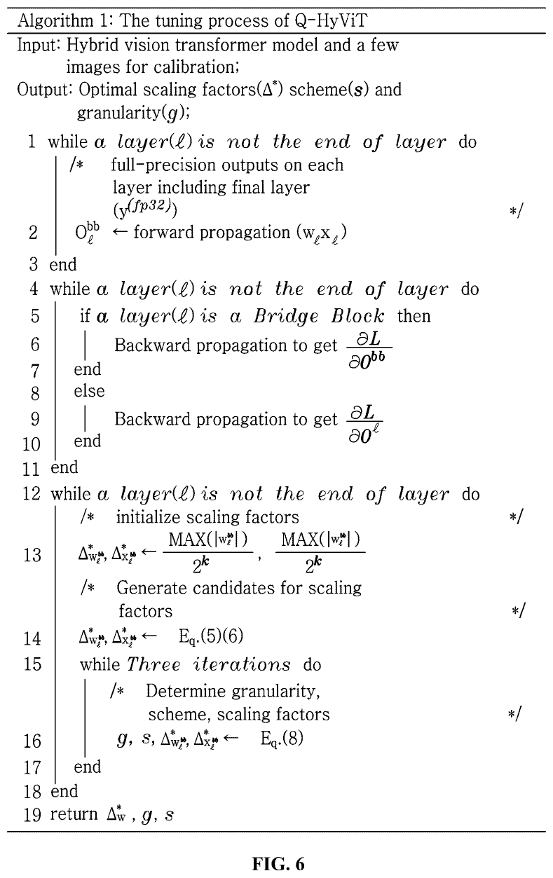

FIG. 6 is an exemplary view of a quantization (Q-HyViT) algorithm of a hybrid vision transformer according to an embodiment.

Referring to FIG. 6, optimal scaling factors, granularity, and quantization scheme are determined using bridge block or layer reconstruction, as described in the quantization (Q-HyViT) algorithm of a hybrid vision transformer according to an embodiment.

According to this embodiment, quantization errors are optimally minimized in the hybrid vision transformer. Here, the output and gradient of each bridge block and layer are calculated through forward propagation and backward propagation in the optimization search process, and all hybrid transformer layers are optimized by reducing reconstruction errors. Finally, the reconstruction errors caused by quantization are minimized, whereby an accurate quantized model is generated.

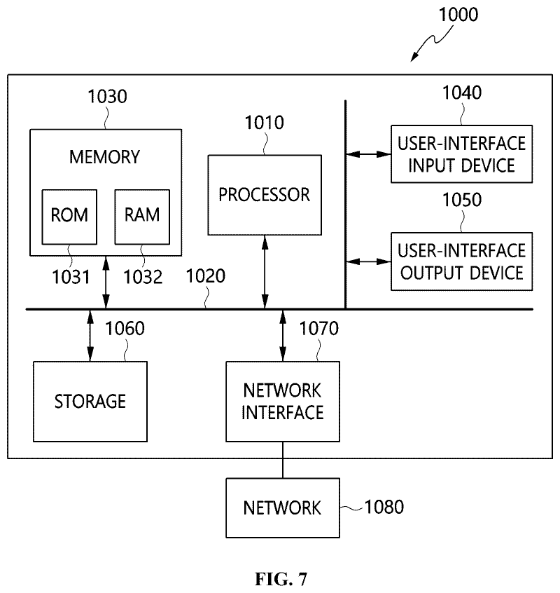

FIG. 7 is a view illustrating a computer system configuration according to an embodiment.

The apparatus for post-training quantization of a hybrid vision transformer according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the disclosed embodiment, because the computational requirements of a hybrid vision transformer are significantly reduced, a model may be effectively executed even in a device having limited resources or an edge-computing environment.

According to the disclosed embodiment, because the accuracy of a model can be maintained or improved through a new Q-HyViT quantization method, a model size and a computational amount may be reduced without performance degradation.

According to the disclosed embodiment, an approach based on post-training quantization (PTQ) enables fast and efficient model calibration, thereby saving development time and resources.

Although the embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. An apparatus for post-training quantization of a hybrid vision transformer, comprising:
memory in which at least one program is recorded; and
a processor for executing the program,
wherein:
the program
calculates a quantization parameter for quantizing a pretrained neural network model, and
calculates the quantization parameter optimized based on a reconstruction error between a first output value of the neural network model before quantization and a second output value of the neural network model after quantization by inputting a predetermined number of pieces of data,
the neural network model is configured with a convolutional neural network and a transformer, and
the convolutional neural network and the transformer are connected by a bridge block.

2. The apparatus of claim 1, wherein the program
optimizes the quantization parameter individually for each of layers included in the convolutional neural network and the transformer, and
optimizes the quantization parameter for all of layers included in the bridge block.

3. The apparatus of claim 2, wherein:
the quantization parameter includes a scaling factor for a weight and a scaling factor for an input activation, and
each of the scaling factors is set within a predetermined search range.

4. The apparatus of claim 3, wherein the quantization parameter further includes granularity for determining a number of scaling factors for each layer.

5. The apparatus of claim 3, wherein the quantization parameter further includes a quantization scheme for determining whether a quantization section is symmetric or asymmetric.

6. A method for post-training quantization of a hybrid vision transformer, comprising:
calculating a quantization parameter for quantizing a pretrained neural network model; and
calculating the quantization parameter optimized based on a reconstruction error between a first output value of the neural network model before quantization and a second output value of the neural network model after quantization by inputting a predetermined number of pieces of data,
wherein:
the neural network model is configured with a convolutional neural network and a transformer, and
the convolutional neural network and the transformer are connected by a bridge block.

7. The method of claim 6, wherein:
the quantization parameter is optimized individually for each of layers included in the convolutional neural network and the transformer, and
the quantization parameter is optimized for all of layers included in the bridge block.

8. The method of claim 7, wherein:
the quantization parameter includes a scaling factor for a weight and a scaling factor for an input activation, and
each of the scaling factors is set within a predetermined search range.

9. The method of claim 8, wherein the quantization parameter further includes granularity for determining a number of scaling factors for each layer.

10. The method of claim 8, wherein the quantization parameter further includes a quantization scheme for determining whether a quantization section is symmetric or asymmetric.

11. A method for post-training quantization of a hybrid vision transformer, comprising:
acquiring a first output value of a pretrained neural network model by inputting a predetermined number of pieces of data; and
calculating a quantization parameter optimized based on a reconstruction error between the first output value and a second output value of a quantized neural network model,
wherein:
the neural network model is configured with a convolutional neural network and a transformer, and
the convolutional neural network and the transformer are connected by a bridge block.

12. The method of claim 11, wherein:
the quantization parameter includes a scaling factor for a weight and a scaling factor for an input activation, and
each of the scaling factors is set within a predetermined search range.

13. The method of claim 12, wherein the quantization parameter further includes granularity for determining a number of scaling factors for each layer.

14. The method of claim 12, wherein the quantization parameter further includes a quantization scheme for determining whether a quantization section is symmetric or asymmetric.

15. The method of claim 11, wherein calculating the quantization parameter includes
acquiring the second output value of the quantized neural network model individually for each of layers included in the convolutional neural network and the transformer and thereby calculating an error between the second output value and the first output value, and
acquiring the second output value of the quantized neural network model for all of layers included in the bridge block and thereby calculating an error between the second output value and the first output value.

16. The method of claim 15, wherein calculating the quantization parameter further includes
acquiring a gradient value for each layer or the bridge block through error backpropagation of a second neural network model after a predetermined number of pieces of data is input to the pretrained second neural network model and propagated in a forward direction.

17. The method of claim 12, wherein calculating the quantization parameter includes generating a predetermined number of candidates for the quantization parameter for each layer of the neural network model within a predetermined range.

18. The method of claim 17, wherein calculating the quantization parameter further includes searching for a quantization parameter that minimizes an error by alternately selecting quantization parameters included in the candidates for the quantization parameter for each layer.

19. The method of claim 18, wherein searching for the quantization parameter comprises optimizing the quantization parameter using a diagonal matrix that has the calculated error and a square of a gradient value acquired for each layer as elements thereof.
